(19) United States
(12) Patent Application Publication
(10) Pub. No.: US 2025/0317735 A1
(43) Pub. Date: Oct. 9, 2025

(54) METHODS AND SYSTEMS FOR POINT-OF-USE TOKEN VALIDATION WITH A CORE ACCESS NETWORK ELEMENT

(71) Applicant: T-Mobile Innovations LLC, Overland Park, KS (US)

(72) Inventor: Mark ALLEN, Renton, WA (US)

(73) Assignee: T-Mobile Innovations LLC, Overland Park, KS (US)

(21) Appl. No.: 18/626,120

(22) Filed: Apr. 3, 2024

(51) Int. Cl. H04W 12/084; H04W 12/06; H04W 12/72

(52) U.S. Cl. CPC H04W 12/084; H04W 12/06; H04W 12/72

(57) ABSTRACT

A method comprises performing, by a core access network element in a core network, a registration of a first client with the IMS core network based on an identifier of the first client and an access token associated with the first client, maintaining, by the core access network element, the registration of the first client with the IMS core network, receiving, by the core access network element, an access request from the first client, wherein the access request comprises the access token of the first client and the identifier of the first client, authenticating, by an authorization server, the access token in association with the first client, verifying, by an identity management server, a permission associated with the first client to use the access token to access the core network.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

An Internet Protocol (IP) Media Subsystem (IMS) core network is a network or framework for delivering multimedia services over IP networks. The IMS core network may be a standardized architecture defined by the 3^{rd} Generation Partnership Project (3GPP) for delivering voice, video, messaging, and other services over IP-based networks, including both mobile and fixed networks. IMS enables the convergence of traditional telecommunications services with IP-based services, allowing for a more flexible and efficient delivery of multimedia services. An IMS core network may provide telecommunications services to users or customers of the telecommunications service providing company operating the IMS core. The telecommunications services provided by the IMS are being opened up to developers via publicly accessible API endpoints.

### SUMMARY

In an embodiment, a method implemented in a communication network including an Internet Protocol (IP) Media Subsystem (IMS) core network to perform point-of-use token validation is disclosed. The method comprises receiving, by a core application executing at a core access network element in the IMS core network, a registration message from a client, in which the registration message comprises a first access token and a mobile station international subscriber directory number (MSISDN) of the client. The method further comprises authenticating, by an authorization application at an authorization server communicatively coupled to the IMS core network, the first access token based on a current and valid access token assigned to the client, and verifying, by an identity application at an identity management server communicatively coupled to the IMS core network, that the MSISDN of the client is indicated as being permitted to use the first access token based on a client account associated with the client. The method further comprises performing, by the core application at the IMS core network, a registration of the client with the IMS core network based on the MSISDN of the client, and maintaining, by the core application, the registration of the client with the IMS core network by automatically performing one or more refresh operations on the registration of the client with the IMS core network. The method then comprises receiving, by the core application, an access request from the client, in which the access request comprises a second access token of the client, the MSISDN of the client, an indication of a requested service, and a MSISDN of a second client, wherein the requested service is to complete a call from the client to the second client, authenticating, by the authorization application at the authorization server, the second access token based on the current and valid access token assigned to the client, verifying, by the identity application at the identity management server, at least one of the MSISDN of the client, the MSISDN of the second client, or the requested service based on the client account, and providing, by the IMS core network, the requested service to the client.

In another embodiment, a method implemented in a communication network including an Internet Protocol (IP) Media Subsystem (IMS) core network to perform point-of-use token validation is disclosed. The method comprises performing, by a core application executing at a core access network element in the IMS core network, a registration of a first client with the IMS core network based on a mobile station international subscriber directory number (MSISDN) of the first client and an access token associated with the first client, and maintaining, by the core application, the registration of the first client with the IMS core network based on the access token used while performing the registration of the first client with the IMS core. The method also comprises receiving, by the core application, an access request for a requested service from a second client, wherein the requested service is to complete a call from the second client to the first client, transmitting, by the core application to the first client, an incoming service notification indicating that an anonymized service has been requested involving the first client, and in response to transmitting the incoming service notification to the first client, receiving, by the core application, an access request from the first client, wherein the access request comprises the access token of the first client and the MSISDN of the first client. The method further comprises authenticating, by an authorization application at an authorization server communicatively coupled to the IMS core network, the access token based on a current and valid access token assigned to the first client, verifying, by an identity application at an identity management server communicatively coupled to the IMS core network, at least one of the MSISDN of the first client, a second MSISDN identifying the second client, or the requested service based on a client account associated with the first client, and completing, by the IMS core network, the requested service between the second client and the first client.

In an embodiment, a communication network is disclosed. The communication network comprises a core access network element, an authorization server, and an identity management server. The core access network element comprises a non-transitory memory, a processor coupled to the non-transitory memory, and a core application stored at the non-transitory memory, which when executed by the processor, causes the processor to be configured to perform a registration of a first client with an Internet Protocol (IP) Media Subsystem (IMS) core network based on a mobile station international subscriber directory number (MSISDN) of the first client and an access token associated with the first client, maintain the registration of the first client with the IMS core network by automatically performing one or more refresh operations on the registration of the first client with the IMS core network, and receive an access request for a requested service either from the first client or a second client. The authorization server comprises an authorization application stored at a non-transitory memory of the authorization server, which when executed by a processor of the authorization server, causes the authorization application to be configured to authenticate the access token based on a current and valid access token assigned to the first client. The identity management server comprises an identity application stored at a non-transitory memory of the identity management server, which when executed by a processor of the identity management server, causes the identity application to be configured to verify at least one of the MSISDN of the first client, a second MSISDN identifying the second client, or the requested service based on a client account associated with the first client. The IMS core network provides the requested service between the first client and the second client in response to the access token being authenticated and the at least one of the MSISDN of the first client, the second MSISDN identifying the second client, or the requested service being validated.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a communication network according to an embodiment of the disclosure.

FIGS. 2A-C are message sequence diagrams illustrating communications between various components of the communication network to implement point-of-use token validation according to various embodiments of the disclosure.

FIG. 3 is a flowchart of a first method of point-of-use token validation according to various embodiments of the disclosure.

FIG. 4 is a flowchart of a second method of point-of-use token validation according to various embodiments of the disclosure.

FIGS. 5A-B are block diagrams illustrating a communication system similar to the communication system of FIG. 1 according to an embodiment of the disclosure.

FIG. 6 is a block diagram of a computer system implemented within the communication system of FIG. 1 according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

As mentioned above, the IMS core network may deliver services to clients over IP networks. The services provided by the IMS core network may include, for example, voice services (e.g., voice calls), video services (e.g., video calls and video conferencing), messaging services (e.g., text messaging (SMS) and multimedia messaging (MMS)), presence and availability sharing (e.g., sharing of user presence and availability data), etc.

A client (i.e., a client device) may use the services provided by the IMS core network when the user operating the client is a registered customer of the telecommunications service providing (TSP) company operating the IMS core network. The client may use the services provided by the IMS core network when the user behind the client maintains a client account associated with the TSP company. For example, the user may access a website or application of the TSP company and enter security credentials (e.g., username and password) into the website or application via a user interface. The security credentials may be used to access the client account of the user at the client.

The client account may include client information (e.g., personally identifiable information (PII), service profiles, subscription information, preferences, etc.) used by the IMS core network to provide services to the client. For example, the client account may include a list of identifiers (e.g., mobile station international subscriber directory numbers (MSISDNs)) identifying devices registered with the user (i.e., permitted to use the services provided by the IMS core network). The devices identified by the MSISDNs listed in the client account may not necessarily be purchased through the TSP company, but may be devices linked to the client account and authorized to use the services provided by the IMS core. As another example, the client account may include permissions associated with one or more of the devices linked to the client account. For example, one device may not be permitted to make long-distance voice calls, another device may only be permitted to send messages within a particular geographical zone, yet another device may not be permitted to send or receive MMS messages, etc.

The client may be any device with access to an application, website, or plug-in associated with the TSP company, through which the security credentials of the user may be entered to access the client account of the user. The client may also be a device programmed with one or more application programming interfaces (APIs) that may securely communicate with various other API endpoints in the communication network (e.g., an authorization server, an identity management server, a core network (NE) in the IMS core network, etc.).

The client may communicate with, for example, the core NE in the IMS core network, the authorization server, and/or the identity management server to register the client with the IMS core network and to use services provided by the IMS core network. The authorization server may be, for example, one or more servers responsible for authenticating the client when the client is attempting to access the IMS core network, as further described herein. The identity management server may be, for example, responsible for permissions of the client before providing the client access to the IMS core network, as further described herein. The phrase “attempting to access the IMS core network” as used herein may refer to accessing (e.g., receiving access to) services or resources provided by the IMS core network.

In some cases, the client may use a token-based authentication scheme to authenticate access to the services provided by the IMS core network. The token-based authentication scheme may involve the generation of an access token, which may include information that is used to identify and authorize the client to access specific resources at the IMS core network on behalf of a user. For example, the access token may be embodied as a string of characters. The access token may represent an authorization granted to the client for accessing resources in the IMS core network. The access token may be accompanied with other information, such as a refresh token. Access tokens may have a limited validity period (e.g., seconds, minutes, hours, or days). When the access token expires, the client may need a new access token to continue accessing resources at the IMS core network.

To obtain the access token, the client may first enter the security credentials via the user interface of the client to access the client account. Once the client has logged into the client account, the client may communicate with the authorization server to perform authorization and schemes (e.g., open authorization) to authenticate the client and obtain the access token (e.g., request an access token from the authorization server and receive the access token (and refresh token) from the authorization server, or generate the access token at the client).

The client may push this access token to a core access NE in the IMS core network periodically or at predefined intervals, to initially register the client with the IMS core network and periodically refresh registration of the client at the IMS core network. The client may need to periodically refresh registration of the client IMS core network to continue accessing resources provided by the IMS core network. For example, the client may push a first access token to the core access NE after completing authenticate with the authorization server. When or slightly before the validity period of the first access token expires, the client may re-authenticate with the authorization server (e.g., using the refresh token received with the first access token) to obtain a second access token, having a new validity period. The client may then push this second access token to the core access NE, and the core access NE may communicate with the authorization server to verify the validity of the second access token (and validate a MSISDN of the client) to refresh the registration of the client at the IMS core network. In this way, the client may push access tokens to the core access NE periodically according to a predefined schedule or in response to a new access token being created for the client.

However, the continuous pushing of the updated access tokens to the core access NE is largely resource intensive and may involve the client continuously re-registering with the authorization server and the core access NE, regardless of whether the client is actually using services or resources at the IMS core network at that moment. For example, continuously re-authenticating with the authorization server and pushing new access tokens to the core access NE may involve a heavy processing load at the client, a heavy bandwidth load at the network, and a heavy storage load at all the servers to continuously maintain updated access tokens for the client. In addition, clients that use the token-based authentications schemes to access the IMS core network may be limited in that the clients may have to be devices with a sufficient amount of power to continuously re-obtain access tokens and/or push the access tokens to the core access NE. This may be especially problematic for low-power devices, such as Internet-of-Things (IoT) devices.

The present disclosure addresses the foregoing technical problems by providing a technical solution in the technical field of token-based authentication of clients with an IMS core network. Instead of the client periodically re-authenticating with the authentication server and refreshing the registration at the IMS core with updated access tokens, the embodiments disclosed herein are directed to performing point-of-use token validation. In various embodiments, performing point-of-use token validation involves the client first obtaining an updated access token and providing the updated access token to the core NE only when the client is requesting (or otherwise about to receive) access to the services and resources provided by the IMS core network. In this way, the client may not necessarily need to constantly update the access token upon expiry and repeatedly push the access token to the core access NE to re-register with the IMS core network even when the client is not currently using the IMS core network. Instead, the embodiments disclosed herein may enable the client to only update the access token and/or only push the access token to the core access NE when the client is initiating a new request for a service using the IMS core network. Moreover, using the embodiments disclosed herein, the client may no longer need to re-register with the IMS core network with new access tokens. Instead, the core access NE may be responsible for maintaining the registration of the client with the IMS core network based on the first registration of the client with the IMS core network.

As mentioned above, the pertinent communication network for the embodiments disclosed herein may include the IMS core network, the authorization server, the identity management server, and one or more clients. The IMS core network may include a core access NE positioned at an edge of the IMS core network, and many other applications and nodes not otherwise detailed herein. In some embodiments, the IMS core network may include the authorization server and the identity management server, and in other embodiments, the authorization server and the identity management server may be external to the IMS core network. The clients may refer to devices that may or may not be operated by users of the IMS core network, and thus, may or may not be permitted to use the services and resources at the IMS core network.

A first client may include a client application that enters security credentials into a website or application of the TSP company, which then authorizes the first client access to the client account associated with the first client and the authorization server. The first client then communicates with an authorization application at the authorization server to obtain (e.g., generate by the first client or receive from the authentication server) a first access token and a refresh token, using one or more authentication methods. For example, when the authorization server is an Open Authorization (OAuth) server, the authorization and authentication methods used to obtain the first access token and a refresh token may be based on an OAuth framework. However, it should be appreciated that the client application and the authorization application may use any type of authorization and authentication scheme, which is not limited herein. The authorization application may then set the first access token as the valid token for the first client for a validity period.

The first client may then transmit a registration message to a core application at the core access NE of the IMS core network. The registration message may include the first access token and an identifier of the first client. For example, the identifier of the first client may be a MSISDN of the first client. The MSISDN may be a unique identifier assigned to the first client and identifying the first client (e.g., the MSISDN may be a phone number associated with the first client).

The core application at the core access NE may extract the first access token from the registration message and transmit the first access token to the authorization server. The authorization application at the authorization server may validate the first access token as being a current valid access token assigned to the client, correctly identifying and authenticating the client. The authorization application may generate an authorization parameter indicating whether the first access token received from the first client is valid based on the security credentials associated with the client account, and then return the authorization parameter to the core application.

If the authorization parameter indicates that the first access token is valid, the core application may next communicate with the identity application at the identity management server to verify that the client is permitted to access the services and resources at the IMS core network. For example, the identity application may validate that client identified by the MSISDN is permitted to use the first access token to access services and resources at the IMS core network. The identity application may communicate with the authorization application depending on the management of permissions and identities at the identity management server to perform this validation. The identity application may generate a validation parameter indicating whether the client identified by the MSISDN is permitted to use the first access token to access the IMS core network, and return the validation parameter to the identity application. If the validation parameter indicates that the client identified by the MSISDN is permitted to use the first access token to access the IMS core network, the core application may complete registration of the first client with the IMS core network.

To register the first client with the IMS core network, the core application may transmit a session initiation protocol (SIP) register message including the MSISDN of the client to a function or node in the IMS core network (e.g., a home subscriber server (HSS)). The client or node in the IMS core may indicate, for example, in a database of the IMS core network that the client identified by the MSISDN has been validated and authorized to use the services and resources of the IMS core network.

Once registration is complete, the first client may continue to access the IMS core network without manually refreshing the registration using updated access tokens. To this end, the core application may maintain the registration of the first client with the IMS core network, without requiring the client to provide an updated access token when the first access token expires. Instead, the core application may maintain the registration of the first client with the IMS core network for a configurable amount of time that may not be related to the validity period of the first access token by, for example, periodically performing one or more refresh operations on the registration of the client with the IMS core network. The one or more refresh operations may involve sending another SIP register message including the MSISDN of the client to the function or node at the IMS core network, and waiting for a SIP response confirming refreshing of the registration. In this way, when the first access token expires, the core application may retain the registration of the client with the IMS core network even though the first access token used for registration is no longer valid. Instead, the client may only provide an updated access token to the core application upon requesting a service using the IMS core network.

For example, after registration with the IMS core network, the first client may transmit an access request to the core application at the core access NE. The access request may include, for example, an updated access token (which may be the first access token or a second, different access token), a MSISDN of the first client, and/or an MSISDN of a second client (sometimes referred to herein as a “destination client”). The access request may also indicate a requested service (e.g., request for a call from the first client to the second client). The second client may or may not be a registered user of the IMS core network.

As mentioned above, the updated access token may be the first access token when the access request is transmitted during a validity period of the first access token. However, when the validity period of the first access token expires, the client may communicate with the authorization server to obtain the second access token using, for example, the refresh token received with the first access token. For example, the client application at the client may receive the second access token from the authorization application or generate the second access token and transmit the second access token to the authorization application. The authorization application may then update a local database to reflect the updated access token as being a current and valid access token assigned to the client.

After receiving the access request, the core application at the core access NE may extract the updated access token from the access request and transmit the updated access token to the authorization server. The authorization server may confirm the validity of the updated access token with relation to the client (e.g., based on the MSISDN) and return, to the core application, an authentication parameter indicating whether the updated access token is valid (e.g., based on the security credentials associated with the client account). If valid, the core application may communicate with the identity application at the identity management server to verify permissions based on the client, the updated access token, and the requested service. The identity application may then return, to the core application, a validation parameter indicating whether the client identified by the MSISDN is permitted to receive the requested service based on the updated access token.

When the authentication parameter and the validation parameter both indicate that the client is authenticated and validated, the core application may instruct the nodes and functions in the IMS core network to provide the requested service to the first client. For example, when the requested service is a call from the first client to the second client, the core application may instruct completion of the call from the first client to the second client using the nodes and functions in the IMS core network.

In another case, a second client, different from the first client and in some cases not a customer or user of the IMS core network, may request a service with relation to the first client. For example, the second client may request completion of a call to the first client or may request the sending of a message to the first client. In this case, the IMS core network may first intercept and receive this incoming access request from the second client, and forward the incoming access request to the core application.

The core application may identify the first client as the destination MSISDN for the incoming access request from the second client. The core application may transmit an incoming service notification to the client, in which the incoming service notification provides minimal detail regarding the incoming access request (e.g., only an indication of a service requested toward the first client). In response, the client may transmit an access request to the core application at the core access NE with the updated access token and the MSISDN of the client. The core access application may communicate with the authorization application and the identity application as described above to authenticate and validate the client to use the IMS core network and receive the requested service from the second client.

In this way, the embodiments disclosed herein serve to conserve processing, networking, and power resources at the system by modifying the system from a periodic token authentication scheme to a point-of-use token authentication scheme, such that the client may no longer push updated access tokens to the core access NE each time a validity period of an access token expires. Therefore, the embodiments disclosed herein increase computer system efficiency across the different servers and networks, while also increasing network communication efficiency (by reducing traffic at the network). In addition, a validity of the requested service is checked by the identity application and the core application at an edge of the IMS core network, as opposed to a function or node deeper within the IMS core network. In this way, the services that may not be permitted for a client may be dropped and filtered out at the edge of the IMS core network, before penetrating further into the IMS core network and leaving the IMS core network more vulnerable to attacks based on the impermissible service request. Therefore, in general, the embodiments disclosed herein serve to increase system capacity by decreasing the load at the clients and the core access NEs and also increase the security within the IMS core network.

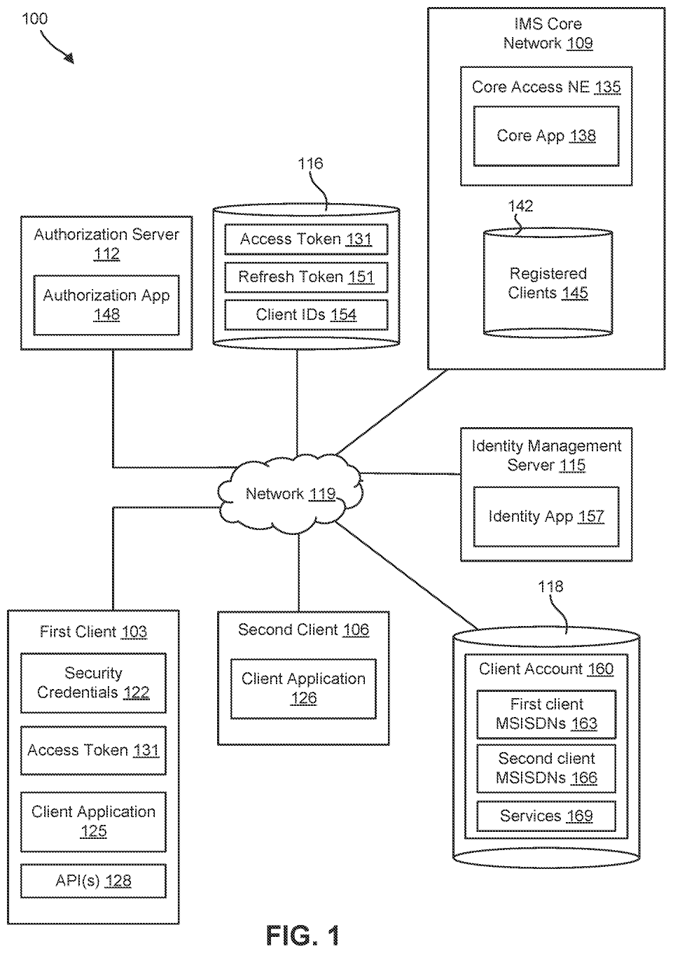

Turning now to FIG. 1, a communication network 100 is described. The communication network 100 includes a first client 103, a second client 106, an IMS core network 109, an authorization server 112, an identity management server 115, data store 116, data store 118, and network 119. Network 119 may be one or more private networks, one or more public networks, or a combination thereof, interconnecting the clients 103, 106, the IMS core network 109, the authorization server 112, the identity management server 115, and the data stores 116, 118. While FIG. 1 illustrates the IMS core network 109, the authorization server 112, the identity management server 115, and the data stores 116, 118 as being separate from the network 119, it should be appreciated that in some embodiments, the IMS core network 109, the authorization server 112, the identity management server 115, and the data stores 116, 118 may be part of the network 119. While FIG. 1 illustrates the authorization server 112, the identity management server 115, and the data stores 116, 118 as being separate from the IMS core network 109, it should be appreciated that in some embodiments, the authorization server 112, the identity management server 115, and the data stores 116, 118 may be part of the IMS core network 109. While FIG. 1 illustrates data stores 116 and 118 as separate data stores, in an embodiment, the data stores 116 and 118 may be co-located together in a single storage system or data center, or located separate from one another across different geographic locations/data centers.

The first client 103 and the second client 106 may be connected to the network 119 using a wired or wireless communication link (e.g., using a local area network or a base station, and communicating to the network 119 via a cellular or WiFi connection). For example, the first client 103 and the second client 106 may communicate with the network according to a 5G, a long term evolution (LTE), a code division multiple access (CDMA), or a global system for mobile communications (GSM) wireless telecommunication protocol.

The first client 103 and the second client 106 may be devices, such as, for example, user equipment (UE), cell phone, a mobile phone, a smart phone, a personal digital assistant (PDA), an Internet of things (IoT) device, a wearable computer, a headset computer, a laptop computer, a tablet computer, or a notebook computer. The first client 103 and the second client 106 may also be, for example, network sites, other storage systems, or other applications that may access the IMS core network 109 (e.g., cloud-based data centers, external applications, etc.).

The first client 103 may be operated by a user that is a customer of the TSP operating the IMS core network 109. In other words, the user of the first client 103 may have possession of security credentials 122 (e.g., a username and password) that may be used to access a client account 160 of the user with the TSP. For example, a user of the first client 103 may enter the security credentials 122 into a website, application, or plug-in associated with the TSP via a user interface of the first client 103, to authenticate the first client 103 with the authorization server 112.

The first client 103 may include a client application 125 and one or more APIs 128. The client application 125 may include instructions stored on a memory of the first client 103, which when executed by a processor of the first client 103, may cause the client application 125 to perform various steps. For example, the client application 125 may receive the security credentials 122 via user input and provide the security credentials 122 to the authorization server 112. The client application 125 may also perform the authorization and authentication communications with the authorization server 112 to obtain an access token 131 (e.g., receive the access token 131 from the authorization server 112 or in some cases generate the access token 131). In this way, the first client 103 may maintain one or more access tokens 131, each of which may have a validity period or a period of time during which the access token 131 is valid. The APIs 128 may be one or more interfaces, with rules and protocols, enabling the first client 103 to securely communicate with various servers, such as the authorization server 112, identity management server 115, the core access NE 135, and one or more nodes or functions at the IMS core network 109.

The second client 106 may be similar to the first client 103, except that the second client 106 may not be operated by a user that is a customer of the TSP operating the IMS core network 109. In other words, the second client 106 may not be linked to client account 160 of the TSP.

The first client 103 may request services and/or resources through the IMS core network 109 to communicate with the second client 106. For example, the first client 103 may request a call to the second client 106 using the IMS core network 109. Similarly, the second client 106 may request services and/or resources through the IMS core network 109 to communicate with the first client 103. For example, the second client 106 may request the transmission of a message from the second client 106 to the first client 103.

The IMS core network 109 may be a sub-network including multiple nodes and functions that provide a framework for delivering multimedia services over IP networks. The IMS core network 109 may converge telecommunications services with IP-based services, allowing for a more flexible and efficient delivery of multimedia services. The IMS core network 109 may consist of various NEs communicatively coupled together and that work together to enable the delivery of services to the first client 103 when registered. For example, the NEs may include a Call Session Control Function (CSCF), a Home Subscriber Server (HSS), a Media Resource Function (MRF), a Breakout Gateway Control Function (BGCF), and Policy and Charging Rules Function (PCRF), etc.

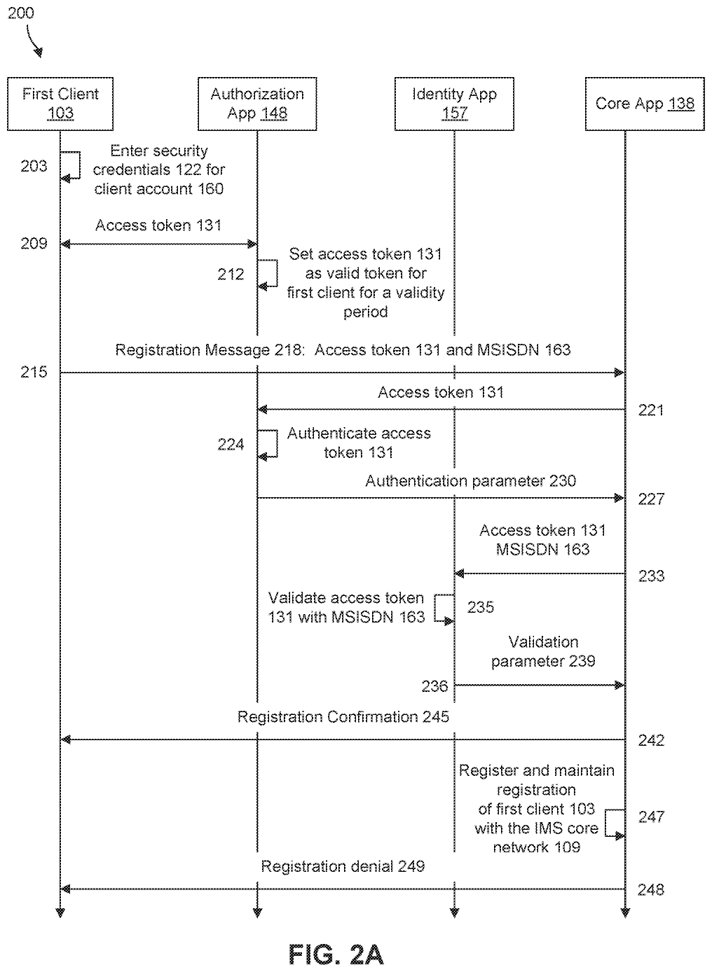

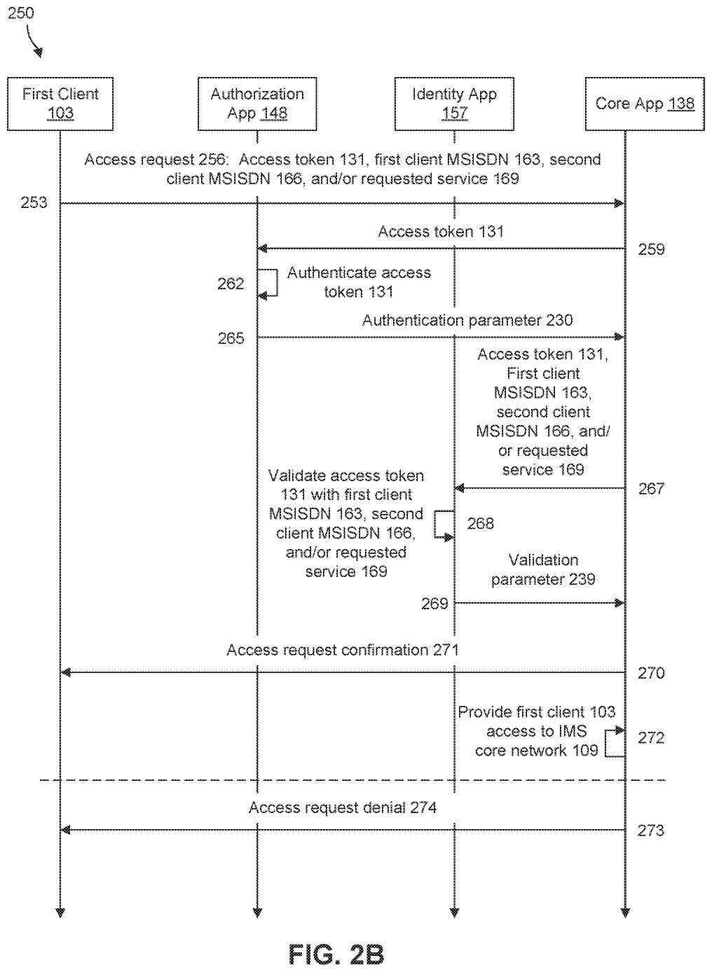

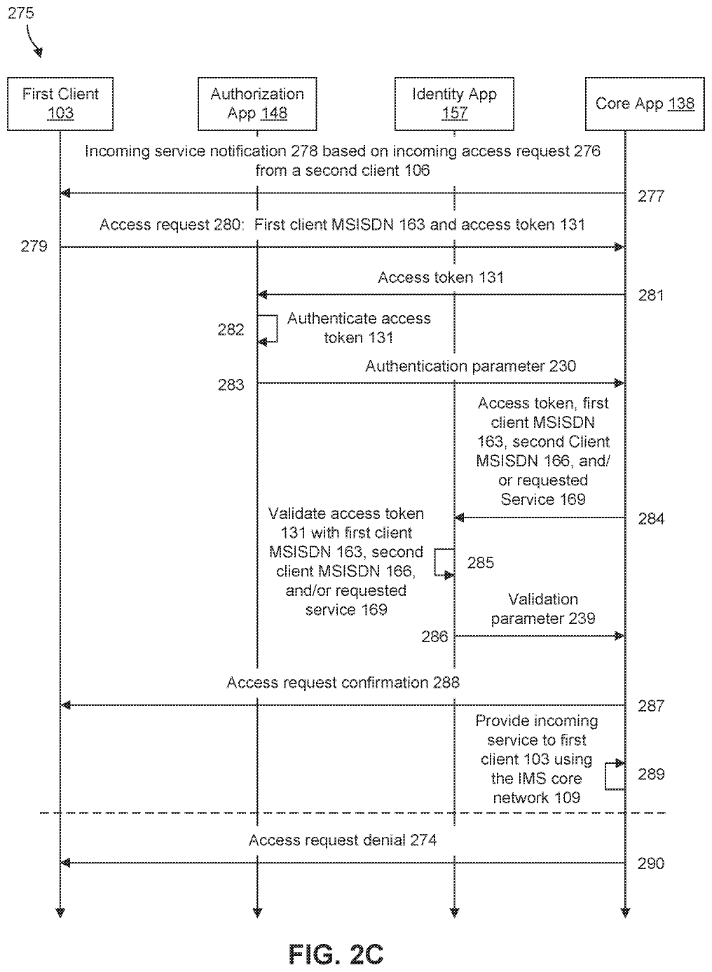

As shown in FIG. 1, the IMS core network 109 includes a core access NE 135, which may be positioned at an edge of the IMS core network 109. The core access NE 135 may be located at a periphery or outer boundary of the IMS core network 109, such that the core access NE 135 interfaces with the different clients 103, 106 and servers 112, 115 in the communication network 100. The core access NE 135 may include a core application 138, which may be instructions stored on a non-transitory memory of the core access NE 135 that when executed, cause the core application 138 to perform various steps as disclosed herein with reference to FIGS. 2A-C.

The IMS core network 109 may also include a data store 142, storing data describing registered clients 145. For example, the core application 138 may register the first client 103 with the IMS core network 109 by adding data describing the first client 103 to the data store 142. As further described herein, the first client 103 may be registered at the IMS core network 109 after, for example, the first client 103 has been authorized at the authorization server 112 and validated at the identity management server 115. To this end, the data describing the first client 103 added to the data store 142 may include, for example, an identifier identifying the first client 103 (e.g., a first client MSISDN 163 identifying the first client 103) and other data identifying the first client 103 (e.g., the access token 131 used to register, an account identifier of the client account 160, etc.).

The authorization server 112 may be a computer system, server software/hardware, or a collection of processors, memories, and/or networking resources used to perform token-based authorization and authentication methods with the first client 103. For example, the authorization server 112 may be implemented as an OAuth server. The authorization server 112 may include an authorization application 148, which may include instructions stored on a memory of the authorization server 112 that when executed by a processor of the authorization server 112, causes the authorization application 148 to perform various steps as disclosed herein in FIGS. 2A-C.

The authorization application 148 may implement various different types of token-based authorization and authentication methods to facilitate secure and authorized access to the IMS core network 109. For example, the authorization application 148 may receive security credentials 122 from the first client 103 to log into the client account 160 associated with the first client 103. The authorization application 148 may initially authenticate the first client 103 when the security credentials 122 are valid and successful in logging-in to the client account 160. The authorization application 148 may also maintain a registry of client applications 125, 126 that are permitted to access the IMS core network 109 (e.g., the client application 125 of the first client 103 may have permission to access the IMS core network 109, but the client application 126 at the second client 106 may not have permission to access the IMS core network 109).

In one case, the authorization application 148 may then provide an access token 131 to the first client 103 in response to, for example, the client application 125 of the first client 103 transmitting a request to the authorization application 148 for the access token 131. The access token 131 may be accompanied with additional information, such as the refresh token 151. The refresh token 151 may include data that may provide a way for the first client 103 to obtain updated access tokens 131 when prior access tokens 131 expire.

The authorization application 148 may store access tokens 131 and refresh tokens 151 in the data store 116 with a client identifier 154 identifying the first client 103. The client identifier 154 may be, for example, the first client MSISDN 163 or another identifier generated by the authorization application 148.

The authorization application 148 may also provide, to the first client 103 and/or the core application 138, updated access tokens 131 in response to receiving a request for an updated access token 131 from the client application 125 and/or the core application 138. For example, when the request includes the refresh token 151 received initially with the first access token 131, the authorization application 148 may provide an updated access token 131 back to the client application 125.

The identity management server 115 may be a computer system, server software/hardware, or a collection of processors, memories, and/or networking resources used to perform token-based authorization and authentication methods with the first client 103. The identity management server 115 may include an identity application 157, which may include instructions stored on a non-transitory memory of the identity management server 115 that when executed by a processor of the identity management server 115, causes the identity application 157 to perform various steps as disclosed herein in FIGS. 2A-C.

The identity application 157 may validate the first client 103 using the access token 131 based on the first client MSISDN 163 to validate that the first client 103 is permitted to use the access token 131. The identity application 157 may also validate that the first client 103 using the access token 131 is permitted to receive the requested service 169 using the IMS core network 109.

For example, the data store 118 may include data regarding various client accounts 160, and one client account 160 may describe data related to the first client 103. The client account 160 may include, for example, a list of first client MSISDNs 163 of first clients 103 that are linked to the client account 160 and thus permitted to access the services and resources at the IMS core network 109 upon registering with the IMS core network 109. The client account 160 may also include a list of second client MSISDNs 166 with which the first clients 103 are permitted to communicate with (e.g., complete calls with, transmit and receive messages/files to and from, etc.) using the IMS core network 109. The client account 160 may also include a list of services 169 that the first clients 103 are permitted to receive and/or access (or prohibited from receiving and accessing) using the IMS core network 109. For example, the list of services 169 may indicate that one or more first clients 103 identified by the first client MSISDNs 163 are not permitted to make long distance calls, or are only permitted to communicate with certain types of second clients 106. The identity application 157 may use the data from the client account 160 stored in the data store 118 to validate that the first client 103 is permitted to use the access token 131 and is permitted to receive access to the IMS core network 109 to receive or complete the requested service 169.

Referring now to FIGS. 2A, 2B, and 2C, shown are message sequence diagrams 200, 250, and 275, respectively. Each of the message sequence diagrams 200, 250, and 275 show communications between the first client 103, authorization application 148, identity application 157, and core application 138 to enable point-of-use token validation for access into the IMS core network 109.

Turning now to FIG. 2A, shown is a message sequence diagram 200 illustrating a first method for registering the first client 103 with the IMS core network 109. At step 203, a user of the first client 103 may enter security credentials 122 into a website or application associated with the TSP operating the IMS core network 109 via a user interface of the first client 103 to access a client account 160 associated with the first client 103. At step 209, the first client 103 (e.g., the client application 125) may communicate with the authorization application 148 to obtain the access token 131 and the refresh token 151. The access token 131 may identify and authenticate the first client 103 for a particular set of services 169. The access token 131 may be obtained in various different manners. For example, the authorization application 148 may generate the access token 131 with a set validity period for the first client 103 and transmit the access token 131 back to the first client 103. The first client 103 may also generate the access token 131 and transmit the access token 131 to the authorization application 148. In either case, at step 212, the authorization application 148 may update the data store 116 to reflect the access token 131 as being the current and valid token for the first client 103 for the duration of the validity period.

At step 215, the first client 103 (e.g., the client application 125) may transmit a registration message 218 to the core application 138 at the core access NE 135. The registration message 218 may include, for example, the access token 131 and the first client MSISDN 163. At step 221, the core application 138 may extract the access token 131 from the registration message 218 and forward the access token 131 to the authorization application 148 at the authorization server 112. At step 224, the authorization application 148 may authenticate the access token 131 by validating that the access token 131 is the current, most up-to-date and valid access token 131 assigned to the first client 103. The authorization application 148 may perform this authentication based on the access tokens 131 stored in association with the client identifier 154 identifying the first client 103 at the data store 116. When the current valid access token 131 stored in the data store 116 matches the access token 131 received in step 215 from the registration message 218, the authorization application 148 may authenticate the access token 131. Then at step 227, the authorization application 148 may send an authentication parameter 230 indicating the authentication of the access token 131 with the first client 103 to the core application 138.

At step 233, the core application 138 may extract the access token 131 and first client MSISDN 163 from the registration message 218, and transmit the access token 131 and first client MSISDN 163 to the identity application 157 at the identity management server 115. At step 235, the identity application 157 may validate the access token 131 with the first client MSISDN 163 by verifying that the first client 103 is permitted to use the access token 131 to access the IMS core network 109. The authorization application 148 may perform this validation based on the client account 160 of the first client 103 stored at the data store 118. For example, the client account 160 at the data store 118 may indicate the first client MSISDNs 163 identifying first clients 103 that are permitted to access the IMS core network 109, the second client MSISDNs 166 identifying second clients 106 that the first clients 103 are permitted to communicate with and/or send data to and from using the IMS core network 109, and the services 169 permitted to be provided to the first clients 103 identified by the first client MSISDNs 163. When the client account 160 indicates that the first client 103 identified by the first client MSISDN 163 is permitted to use the access token 131 (which in some cases may be determined via communications with the authorization application 148), the identity application 157 may validate the access token 131 with the first client MSISDN 163. Then at step 236, the identity application 157 may send a validation parameter 239 indicating the validation of the access token 131 with the first client MSISDN 163 to the core application 138.

When the authentication parameter 230 indicates that the access token 131 has been authenticated by the authorization application 148 and when the validation parameter 239 indicates that the access token 131 has been validated with the first client MSISDN 163, at step 242, the core application 138 may transmit a registration confirmation 245 to the first client 103. The registration confirmation 245 may indicate that the first client 103 is successfully registered with the IMS core network 109. Simultaneously, at step 247, the core application 138 may perform the initial registration of the first client 103 with the IMS core network 109 and then maintain the registration for at least a predefined period of time. For example, the core application 138 may send a SIP register message to the HSS at the IMS core network 109 with data describing the first client 103 (e.g., the first client MSISDN 163), such that the HSS updates the data store 142 of registered clients 145 to include the first client 103.

The core application 138 maintains the registration of the first client 103 with the IMS core network 109 for a configurable amount of time that may not be related to the validity period of the access token 131. For example, when the access token 131 expires (e.g., the validity period ends), the core application 138 may retain the registration of the first client 103 with the IMS core network 109 by periodically performing one or refresh operations even though the access token 131 used for registration is no longer valid. The one or more refresh operations may include transmitting another SIP register message with data describing the first client 103 and a SIP response confirming refreshing of the registration of the first client 103.

When the current valid access token 131 stored in the data store 116 does not match the access token 131 received in step 215 from the registration message 218, the authorization application 148 may not authenticate the access token 131. Then at step 227, the authorization application 148 may send an authentication parameter 230 indicating the failure of authenticating the access token 131 with the first client 103 to the core application 138. Then, at step 248, a registration denial 249 may be transmitted back to the first client 103 indicating that the first client 103 is not authorized and authenticated to access the IMS core network 109.

Similarly, when the client account 160 indicates that the first client 103 identified by the first client MSISDN 163 is not permitted to use the access token 131, the identity application 157 may not validate the access token 131 with the first client MSISDN 163. Then at step 236, the identity application 157 may send a validation parameter 239 indicating the failure of validating of the access token 131 with the first client MSISDN 163 to the core application 138. Then, at step 248, a registration denial 249 may be transmitted back to the first client 103 indicating that the first client 103 is not validated to access the IMS core network 109.

Turning now to FIG. 2B, shown is a message sequence diagram 250 illustrating a second method for the first client 103 to request access to services and/or resources at the IMS core network 109, for example, with respect to a second client 106. For example, the first client 103 may be requesting a call with the second client 106 using the IMS core network 109.

At step 253, the first client 103 (e.g., the client application 125) may transmit an access request 256 to the core application 138 at the core access NE 135. For example, the access request 256 may be embodied as a hypertext transfer protocol (HTTP) initiate call. The access request 256 may include the access token 131, the first client MSISDN 163 identifying the first client 103, a second client MSISDN 166 identifying the second client 106, and/or a requested service 169 (e.g., a call with the second client 106). The access token 131 may be the same access token 131 used to register the first client 103 with the IMS core network 109, as described above with reference to FIG. 2A. Alternatively, the access token 131 may be an updated access token 131 obtained by the client application 125 of the first client 103 by re-authenticating with the authorization application 148 of the authorization server 112, for example, using the refresh token and the first client MSISDN 163.

At step 259, the core application 138 may extract the access token 131 from the access request 256, and transmit the access token 131 to the authorization application 148. At step 262, the authorization application 148 may authenticate the access token 131 using methods similar to those described above with reference to FIG. 2A to generate an authentication parameter 230, and transmit the authentication parameter 230 to the core application 139, at step 265.

At step 267, the core application 138 may extract the access token 131, first client MSISDN 163, second client MSISDN 166, and/or requested service 169 from the access request 256, and transmit the access token 131, first client MSISDN 163, second client MSISDN 166, and/or requested service 169 from the access request 256 to the identity application 157 at the identity management server 115. At step 268, the identity application 157 may validate the access token 131 with the first client MSISDN 163, second client MSISDN 166, and/or requested service 169 using the client account 160 of the first client 103 stored in the data store 118. For example, the identity application 157 may verify whether the first client 103 (identified by the first client MSISDN 163) is permitted to use the access token 131 (e.g., in some cases this verification may be performed based on communications with the authorization application 148 based on data in the data store 116). The identity application 157 may also verify whether the first client 103 is permitted to access the services and resources at the IMS core network 109 to communicate with the second client 106 (identified by the second client MSISDN 166) for the requested service 169. The identity application 157 may perform the above-referenced verifications using the information stored in the client account 160 of the first client 103. If verified, the identity application 157 may transmit a validation parameter 239 indicating the validation (e.g., verification) to the core application 138 at step 269.

When the authentication parameter 230 indicates that the access token 131 has been authenticated by the authorization application 148 and when the validation parameter 239 indicates that the access token 131 has been validated with the first client MSISDN 163, second client MSISDN 166, and/or requested service 169, then at step 270, the core application 138 may transmit an access request confirmation 271 to the first client 103. The access request confirmation 271 may indicate that the access request 256 has been accepted and that the requested service 169 with relation to the second client 106 may be permitted to be performed using the IMS core network 109 on behalf of the first client 103. Simultaneously, at step 272, the core application 138 may instruct the nodes and functions in the IMS core network 109 to provide the requested service 169 to the first client 103 (e.g., complete the call from the first client 103 to the second client 106).

When the current valid access token 131 stored in the data store 116 does not match the access token 131 received in step 253 from the access request 256, the authorization application 148 may not authenticate the access token 131. Then at step 265, the authorization application 148 may send an authentication parameter 230 indicating the failure of authenticating the access token 131 with the first client 103 to the core application 138. Then, at step 273, an access request denial 274 may be transmitted back to the first client 103 indicating that the first client 103 is not authorized to receive the requested service 169 with respect to the second client 106.

Similarly, when the client account 160 indicates that the first client 103 identified by the first client MSISDN 163 is not permitted to use the access token 131 to perform the requested service 169 with respect to the second client 106, the identity application 157 may not validate the access token 131 with the first client MSISDN 163. Then at step 269, the identity application 157 may send a validation parameter 239 indicating the failure of validating of the access token 131 to the core application 138. Then, at step 273, an access request denial 274 may be transmitted back to the first client 103 indicating that the first client 103 is not validated to access the IMS core network 109 for the requested services 169 with respect to the second client 106.

Turning now to FIG. 2C, shown is a message sequence diagram 275 illustrating a third method for a second client 106 to request a service with respect to the first client 103 by accessing services and/or resources at the IMS core network 109. For example, the second client 106 may be requesting transmission of a message or file to the first client 103 using the IMS core network 109. This third method may be performed after the second client 106 transmits an access request 276 for transmission of the message or file to the core application 138 at the core access NE 135.

After the core application 138 receives the access request 276 from the second client 106, at step 277, the core application 138 may transmit an incoming service notification 278 to the first client 103. The incoming service notification 278 may include minimal details regarding the access request 276 from the second client 106. For example, the incoming service notification 278 may only include an indication that a service (e.g., an unidentified service) has been requested to be performed relative to the first client 103. For example, the incoming service notification 278 may only include an indication that a message or a file is being requested to be transmitted to the first client 103. The incoming service notification 278 may not include any data describing the second client 106 from which the access request 276 was received. In this way, the incoming service notification 278 may include anonymized data describing the incoming access request 276 from the second client 106.

At step 279, responsive to receiving the incoming service notification 278, the first client 103 (e.g., the client application 125) may transmit an access request 280 to the core application 138 at the core access NE 135. For example, the access request 280 may be embodied as a HTTP initiate call. The access request 280 may include the access token 131 and the first client MSISDN 163. The access request 280 may not include the second client MSISDN 166 identifying the second client 106 and/or a requested service 169, since the first client 103 is not aware of the second client 106 or the requested service 169. The access token 131 may be the same access token 131 used to register the first client 103 with the IMS core network 109, as described above with reference to FIG. 2A. Alternatively, the access token 131 may be an updated access token 131 obtained by the client application 125 of the first client 103.

At step 281, the core application 138 may extract the access token 131 from the access request 280, and transmit the access token 131 to the authorization application 148. At step 282, the authorization application 148 may authenticate the access token 131 using methods similar to those described above with reference to FIG. 2A to generate an authentication parameter 230, and transmit the authentication parameter 230 to the core application 139, at step 283.

At step 284, the core application 138 may extract the access token 131 and the first client MSISDN 163 from the access request 280 received from the first client 103 and extract the second client MSISDN 166 and/or requested service 169 from the access request 276 received from the second client 106. The core application 138 transmits the access token 131, first client MSISDN 163, second client MSISDN 166, and/or requested service 169 to the identity application 157 at the identity management server 115. At step 285, the identity application 157 may validate the access token 131 with the first client MSISDN 163, second client MSISDN 166, and/or requested service 169 using the client account 160 of the first client 103 stored in the data store 118. For example, the identity application 157 may verify whether the first client 103 (identified by the first client MSISDN 163) is permitted to use the access token 131. The identity application 157 may also verify whether the first client 103 is permitted to access the services and resources at the IMS core network 109 to communicate with the second client 106 (identified by the second client MSISDN 166) for the requested services 169. The identity application 157 may perform the above-referenced verifications using the information stored in the client account 160 of the first client 103. If verified, the identity application 157 may transmit a validation parameter 239 indicating the verification to the core application 138 at step 286.

When the authentication parameter 230 indicates that the access token 131 has been authenticated by the authorization application 148 and when the validation parameter 239 indicates that the access token 131 has been validated with the first client MSISDN 163, second client MSISDN 166, and/or requested service 169, then at step 287, the core application 138 may transmit an access request confirmation 288 to the first client 103. The access request confirmation 288 may indicate that the access requests 276 and 280 have been accepted and that the requested service 169 with relation to the second client 106 may be permitted to be performed using the IMS core network 109. Simultaneously, at step 289, the core application 138 provides the incoming service from the second client 106 to the first client 103 using the resources at the IMS core network 109. For example, the core application 139 may complete transmission of the requested message or file from the second client 106 to the first client 103. Alternatively, the core application 139 may instruct completion of the call setup between the second client 106 and the first client 103 based on the access request 276 received from the second client 106.

When the current valid access token 131 stored in the data store 116 does not match the access token 131 received in step 279 from the access request 280, the authorization application 148 may not authenticate the access token 131. Then at step 283, the authorization application 148 may send an authentication parameter 230 indicating the failure of authenticating the access token 131 with the first client 103 to the core application 138. Then, at step 290, an access request denial 274 may be transmitted back to the first client 103 indicating that the first client 103 is not authorized to receive the requested service 169 with respect to the second client 106.

Similarly, when the client account 160 indicates that the first client 103 identified by the first client MSISDN 163 is not permitted to use the access token 131 to perform the requested service 169 with respect to the second client 106, the identity application 157 may not validate the access token 131 with the first client MSISDN 163. Then at step 286, the identity application 157 may send a validation parameter 239 indicating the failure of validating of the access token 131 to the core application 138. Then, at step 290, an access request denial 274 may be transmitted back to the first client 103 indicating that the first client 103 is not validated to access the IMS core network 109 for the requested services 169 with respect to the second client 106.

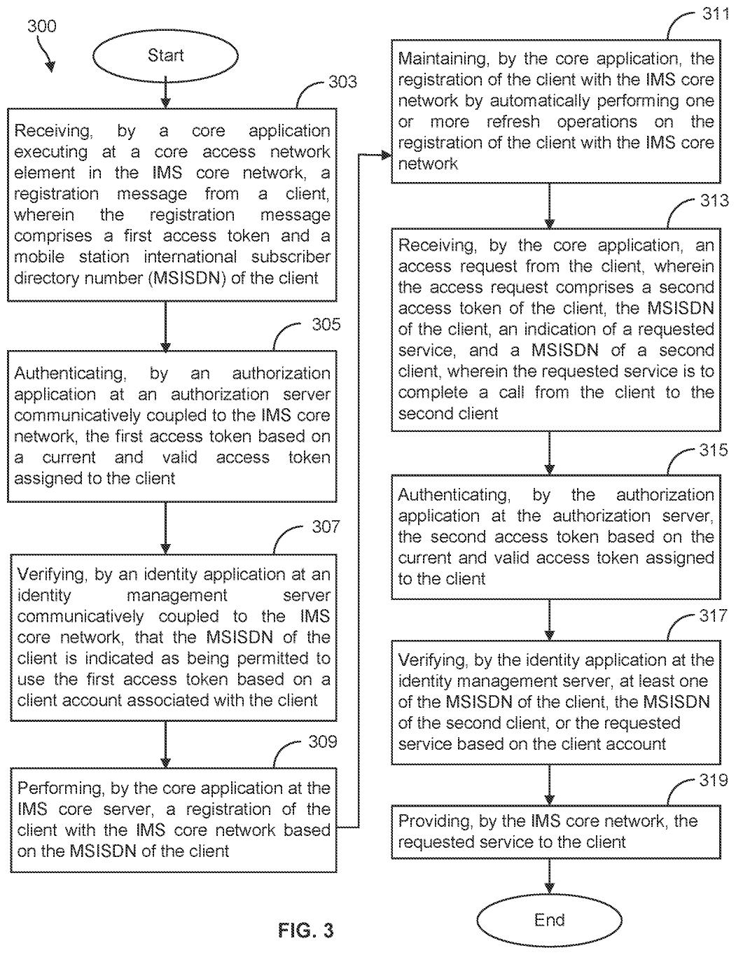

Referring now to FIG. 3, shown is a flowchart illustrating a method 300 for performing point-of-service token authorization and validation to access an IMS core network 109 according to various embodiments of the disclosure. The method 300 may be performed by the core application 138 of the core access NE 135, the authorization application 148 of the authorization server 112, the identity application 157 of the identity management server 115, and the client application 125 of the first client 103. In the description below for FIG. 3, the term “client 103” may refer to the “first client 103.”

At step 303, method 300 may comprise receiving, by a core application 138 executing at a core access NE 135 in the IMS core network 109, a registration message 218 from a first client 103. The registration message 218 may comprise a first access token 131 and a first client MSISDN 163.

At step 305, method 300 may comprise authenticating, by an authorization application 148 at an authorization server 112 communicatively coupled to the IMS core network 109, first access token 131 based on a current, valid access token 131 assigned to the first client 103. At step 307, method 300 may comprise verifying, by an identity application 157 at an identity management server 115 communicatively coupled to the IMS core network 109, that the first client MSISDN 163 is indicated as being permitted to use the first access token 131 based on a client account 160. At step 309, method 300 comprises performing, by the core application 138 at the IMS core network 109, a registration of the client 103 with the IMS core network 109 based on the first client MSISDN 163.

At step 311, method 300 may comprise maintaining, by the core application 138, the registration of the client 130 with the IMS core network 109 by automatically performing one or more refresh operations on the registration of the client 103 with the IMS core network 109. In an embodiment, the one or more refresh operations may be performed based on a predefined schedule or timer accessible by the core application 138, but may otherwise be unrelated to the validity period of the first access token 131.

At step 313, method 300 may comprise receiving, by the core application, an access request 256 from the client 106. The access request 256 comprises a second access token 131 of the client 103, the client MSISDN 163 identifying the client 103, an indication of a requested service 169, and a second client MSISDN 166 identifying the second client 106, wherein the requested service 169 is to complete a call from the client 103 to the second client 106. At step 315, method 300 may comprise authenticating, by the authorization application 148 at the authorization server 112, the second access token 131 based on the current and valid access token 131 assigned to the client 103. At step 317, method 300 may comprise verifying, by the identity application 157 at the identity management server 115, at least one of the first client MSISDN 163 identifying the client 103, the second client MSISDN 166 identifying the second client 106, or the requested service 169 based on the client account 160. At step 319, method 300 comprises providing, by the IMS core network 109, the requested service 169 to the client 103 in response to authenticating the second access token 131 and validating at least one of the first client MSISDN 163 identifying the client 103, the second client MSISDN 166 identifying the second client 106, or the requested service 169.

Method 300 may include other steps and/or features that are not otherwise shown in FIG. 3. In an embodiment, the first access token 131 has a validity time period, and wherein after the validity time period, the first access token 131 is expired and the second access token 131 becomes valid. In an embodiment, method 300 may further comprise receiving, by the authorization application 148 at the authorization server 112, security credentials 122 to access the client account 160, and verifying, by the authorization application 148 at the authorization server 112, a validity of the first access token 131 in response to accessing the client account 160.

In an embodiment, method 300 may further comprise obtaining, by the identity application 157 of the identity management server 115, a validation parameter 239 indicating that the first client MSISDN 163 identifying the client 103 is permitted to use the first access token 131 based on the client account 160. In an embodiment, wherein performing, by the core application 138, the registration of the client 103 with the IMS core network 109 based on the first client MSISDN 163 comprises transmitting, by the core application 138 to a registration application (e.g., HSS) at the IMS core network 109, a session initiation protocol (SIP) register message comprising the first client MSISDN 163, and receiving, by the core application 138 from the registration application, a SIP response message indicating a status of performing the registration of the client 103 with the IMS core network 109. In an embodiment, the one or more refresh operations comprises transmitting another SIP register message comprising the first client MSISDN 163 according to a predefined schedule.

In an embodiment, prior to receiving, by the core application 138, the access request 256 from the client 103, method 400 may further comprise receiving, by the authorization application 148 at the authorization server 112, a refresh token 151 associated with the client 103 and the first access token 131 from the client 103, authenticating, by the authorization application 148 at the authorization server 112, the client 103 based on both the refresh token 151 and the first access token 131, and providing, by the authorization application 148 at the authorization server 112, the second access token 131 to the client 103. In an embodiment, the client account 160 comprises a list of first client MSISDNs 163 identifying clients that are permitted to access the IMS core network 109, a list of second client MSISDNs 166 identifying second clients that the clients are permitted to communicate with using the IMS core network 109, and a list of services 169 that the clients are permitted to receive using the IMS core network 109.

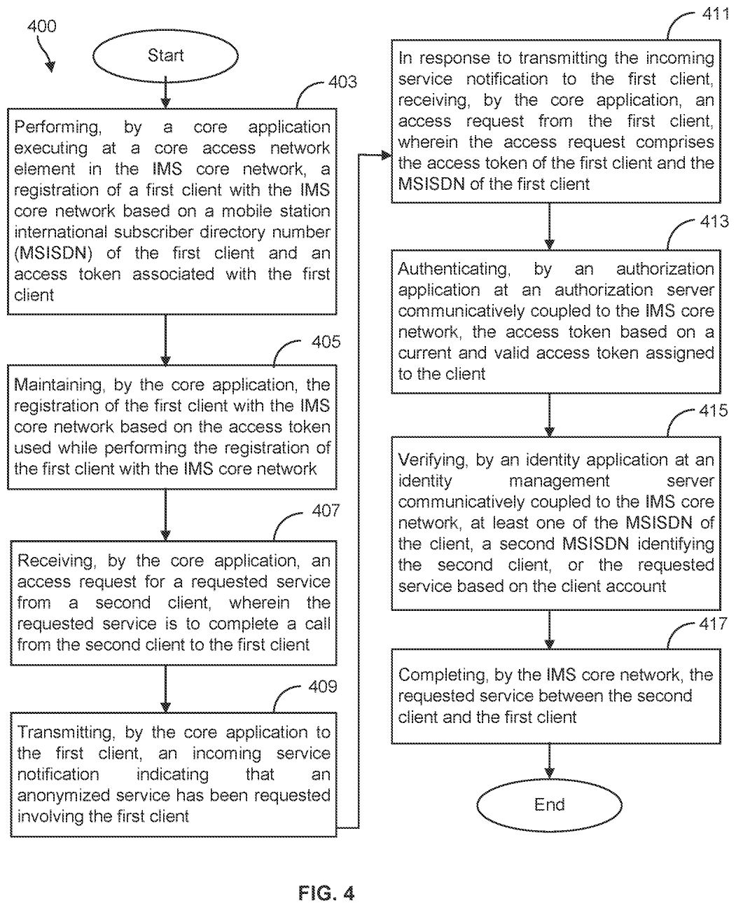

Referring now to FIG. 4, shown is a flowchart illustrating a method 400 for performing point-of-service token authorization and validation to access an IMS core network 109 according to various embodiments of the disclosure. The method 400 may be performed by the core application 138 of the core access NE 135, the authorization application 148 of the authorization server 112, the identity application 157 of the identity management server 115, and the client application 125 of the first client 103.

At step 403, method 400 may comprise performing, by a core application 138 executing at a core access NE 135 in the IMS core network 108, a registration of a first client 103 with the IMS core network 109 based on a first client MSISDN 163 identifying the first client and an access token 131 associated with the first client. At step 405, method 400 may comprise maintaining, by the core application 138, the registration of the first client 103 with the IMS core network 109 based on the access token 131 used while performing the registration of the first client 103 with the IMS core network 109. At step 407, method 400 may comprise receiving, by the core application 138, an access request 280 for a requested service 169 from a second client 106, wherein the requested service 169 is to complete a call from the second client 106 to the first client 103. At step 409, method 400 may comprise transmitting, by the core application 138 to the first client 103, an incoming service notification 278 indicating that an anonymized service has been requested involving the first client 103.

At step 411, method 400 may comprise, in response to transmitting the incoming service notification 278 to the first client 103, receiving, by the core application 138, an access request 280 from the first client 103. The access request 280 may comprise the access token 131 of the first client 103 and the first client MSISDN 163. At step 413, method 400 may comprise authenticating, by an authorization application 148 at an authorization server 112 communicatively coupled to the IMS core network 109, the access token 131 based on a current and valid access token assigned to the client 103. At step 415, method 400 may comprise verifying, by an identity application 157 at an identity management server 115 communicatively coupled to the IMS core network 109, at least one of the first client MSISDN 163 identifying the first client 103, a second client MSISDN 166 identifying the second client 106, or the requested service 169 based on the client account 160. At step 417, method 400 may comprise completing, by the IMS core network 109, the requested service 169 between the second client 106 and the first client 103.

Method 400 may include other steps and/or features that are not otherwise shown in FIG. 4. In an embodiment, the access token 131 has a validity time period during which the access token 131 is valid. In an embodiment, method 400 may further comprise receiving, by the authorization application 148 at the authorization server 112, security credentials 122 to access the client account 160, and verifying, by the authorization application 148 at the authorization server 112, a validity of the first access token 131 in response to accessing the client account 160. In an embodiment, wherein performing, by the core application 138, the registration of the client 103 with the IMS core network 109 based on the first client MSISDN 163 comprises transmitting, by the core application 138 to a registration application (e.g., HSS) at the IMS core network, a session initiation protocol (SIP) register message comprising the first client MSISDN 163, and receiving, by the core application 138 from the registration application, a SIP response message indicating a status of performing the registration of the client 103 with the IMS core network 109. In an embodiment, the one or more refresh operations comprises transmitting another SIP register message comprising the first client MSISDN 163 according to a predefined schedule.

In an embodiment, method 400 may further comprise receiving, by the authorization application 148 at the authorization server 112, a refresh token 151 associated with the first client 103 and the access token 131, verifying, by the authorization application 148 at the authorization server 112, a validity of the access token 131, and transmitting, by the authorization application 148 at the authorization server 112, to the first client 103, a notification that the access token 131 is still valid for the client 103 (e.g., the validity time period of the access token 131 has not yet expired).

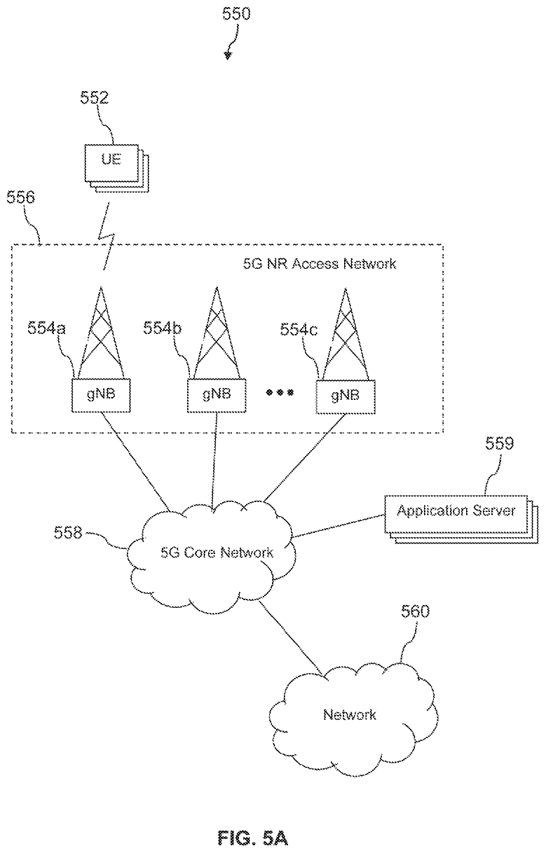

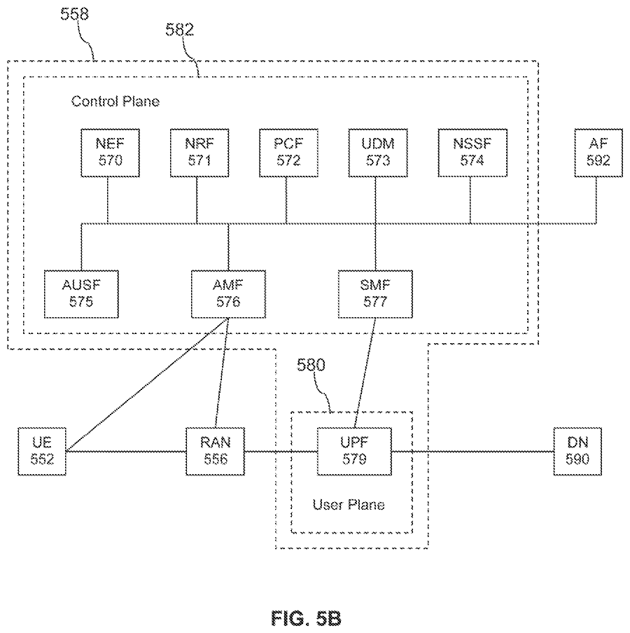

Turning now to FIG. 5A, an exemplary communication system 550 is described. In an embodiment, the communication system 550 may be implemented in the network 100 of FIG. 1. The communication system 550 includes a number of access nodes 554 that are configured to provide coverage in which UEs 552, such as cell phones, tablet computers, machine-type-communication devices, tracking devices, embedded wireless modules, and/or other wirelessly equipped communication devices (whether or not user operated), or devices such as end user device 102 and the MEC server 107, can operate. The access nodes 554 may be said to establish an access network 556. The access network 556 may be referred to as RAN in some contexts. In a 5G technology generation an access node 554 may be referred to as a gigabit Node B (gNB). In 4G technology (e.g., LTE technology) an access node 554 may be referred to as an eNB. In 3G technology (e.g., CDMA and GSM) an access node 554 may be referred to as a base transceiver station (BTS) combined with a base station controller (BSC). In some contexts, the access node 554 may be referred to as a cell site or a cell tower. In some implementations, a picocell may provide some of the functionality of an access node 554, albeit with a constrained coverage area. Each of these different embodiments of an access node 554 may be considered to provide roughly similar functions in the different technology generations.

In an embodiment, the access network 556 comprises a first access node 554a, a second access node 554b, and a third access node 554c. It is understood that the access network 556 may include any number of access nodes 554. Further, each access node 554 could be coupled with a core network 558 that provides connectivity with various application servers 559 and/or a network 560. In an embodiment, at least some of the application servers 559 may be located close to the network edge (e.g., geographically close to the UE 552 and the end user) to deliver so-called “edge computing.” The network 560 may be one or more private networks, one or more public networks, or a combination thereof. The network 560 may comprise the public switched telephone network (PSTN). The network 560 may comprise the Internet. With this arrangement, a UE 552 within coverage of the access network 556 could engage in air-interface communication with an access node 554 and could thereby communicate via the access node 554 with various application servers and other entities.

The communication system 550 could operate in accordance with a particular radio access technology (RAT), with communications from an access node 554 to UEs 552 defining a downlink or forward link and communications from the UEs 552 to the access node 554 defining an uplink or reverse link. Over the years, the industry has developed various generations of RATs, in a continuous effort to increase available data rate and quality of service for end users. These generations have ranged from “1G,” which used simple analog frequency modulation to facilitate basic voice-call service, to “4G”-such as Long Term Evolution (LTE), which now facilitates mobile broadband service using technologies such as orthogonal frequency division multiplexing (OFDM) and multiple input multiple output (MIMO).

Recently, the industry has been exploring developments in “5G” and particularly “5G NR” (5G New Radio), which may use a scalable OFDM air interface, advanced channel coding, massive MIMO, beamforming, mobile mmWave (e.g., frequency bands above 24 GHz), and/or other features, to support higher data rates and countless applications, such as mission-critical services, enhanced mobile broadband, and massive Internet of Things (IoT). 5G is hoped to provide virtually unlimited bandwidth on demand, for example providing access on demand to as much as 20 gigabits per second (Gbps) downlink data throughput and as much as 10 Gbps uplink data throughput. Due to the increased bandwidth associated with 5G, it is expected that the new networks will serve, in addition to conventional cell phones, general internet service providers for laptops and desktop computers, competing with existing ISPs such as cable internet, and also will make possible new applications in internet of things (IoT) and machine to machine areas.

In accordance with the RAT, each access node 554 could provide service on one or more radio-frequency (RF) carriers, each of which could be frequency division duplex (FDD), with separate frequency channels for downlink and uplink communication, or time division duplex (TDD), with a single frequency channel multiplexed over time between downlink and uplink use. Each such frequency channel could be defined as a specific range of frequency (e.g., in radio-frequency (RF) spectrum) having a bandwidth and a center frequency and thus extending from a low-end frequency to a high-end frequency. Further, on the downlink and uplink channels, the coverage of each access node 554 could define an air interface configured in a specific manner to define physical resources for carrying information wirelessly between the access node 554 and UEs 552.

Without limitation, for instance, the air interface could be divided over time into frames, subframes, and symbol time segments, and over frequency into subcarriers that could be modulated to carry data. The example air interface could thus define an array of time-frequency resource elements each being at a respective symbol time segment and subcarrier, and the subcarrier of each resource element could be modulated to carry data. Further, in each subframe or other transmission time interval (TTI), the resource elements on the downlink and uplink could be grouped to define physical resource blocks (PRBs) that the access node could allocate as needed to carry data between the access node and served UEs 552.

In addition, certain resource elements on the example air interface could be reserved for special purposes. For instance, on the downlink, certain resource elements could be reserved to carry synchronization signals that UEs 552 could detect as an indication of the presence of coverage and to establish frame timing, other resource elements could be reserved to carry a reference signal that UEs 552 could measure in order to determine coverage strength, and still other resource elements could be reserved to carry other control signaling such as PRB-scheduling directives and acknowledgement messaging from the access node 554 to served UEs 552. And on the uplink, certain resource elements could be reserved to carry random access signaling from UEs 552 to the access node 554, and other resource elements could be reserved to carry other control signaling such as PRB-scheduling requests and acknowledgement signaling from UEs 552 to the access node 554.

The access node 554, in some instances, may be split functionally into a radio unit (RU), a distributed unit (DU), and a central unit (CU) where each of the RU, DU, and CU have distinctive roles to play in the access network 556. The RU provides radio functions. The DU provides L1 and L2 real-time scheduling functions; and the CU provides higher L2 and L3 non-real time scheduling. This split supports flexibility in deploying the DU and CU. The CU may be hosted in a regional cloud data center. The DU may be co-located with the RU, or the DU may be hosted in an edge cloud data center.

Turning now to FIG. 5B, further details of the core network 558 are described. In an embodiment, the core network 558 is a 5G core network. 5G core network technology is based on a service based architecture paradigm. Rather than constructing the 5G core network as a series of special purpose communication nodes (e.g., an HSS node, an MME node, etc.) running on dedicated server computers, the 5G core network is provided as a set of services or network functions. These services or network functions can be executed on virtual servers in a cloud computing environment which supports dynamic scaling and avoidance of long-term capital expenditures (fees for use may substitute for capital expenditures). These network functions can include, for example, a user plane function (UPF) 579, an authentication server function (AUSF) 575, an access and mobility management function (AMF) 576, a session management function (SMF) 577, a network exposure function (NEF) 570, a network repository function (NRF) 571, a policy control function (PCF) 572, a unified data management (UDM) 573, a network slice selection function (NSSF) 574, and other network functions. The network functions may be referred to as virtual network functions (VNFs) in some contexts.

Network functions may be formed by a combination of small pieces of software called microservices. Some microservices can be re-used in composing different network functions, thereby leveraging the utility of such microservices. Network functions may offer services to other network functions by extending application programming interfaces (APIs) to those other network functions that call their services via the APIs. The 5G core network 558 may be segregated into a user plane 580 and a control plane 582, thereby promoting independent scalability, evolution, and flexible deployment.

The UPF 579 delivers packet processing and links the UE 552, via the access network 556, to a data network 590 (e.g., the network 560 illustrated in FIG. 5A). The AMF 576 handles registration and connection management of non-access stratum (NAS) signaling with the UE 552. Said in other words, the AMF 576 manages UE registration and mobility issues. The AMF 576 manages reachability of the UEs 552 as well as various security issues. The SMF 577 handles session management issues. Specifically, the SMF 577 creates, updates, and removes (destroys) protocol data unit (PDU) sessions and manages the session context within the UPF 579. The SMF 577 decouples other control plane functions from user plane functions by performing dynamic host configuration protocol (DHCP) functions and IP address management functions. The AUSF 575 facilitates security processes.

The NEF 570 securely exposes the services and capabilities provided by network functions. The NRF 571 supports service registration by network functions and discovery of network functions by other network functions. The PCF 572 supports policy control decisions and flow based charging control. The UDM 573 manages network user data and can be paired with a user data repository (UDR) that stores user data such as customer profile information, customer authentication number, and encryption keys for the information. An application function 592, which may be located outside of the core network 558, exposes the application layer for interacting with the core network 558. In an embodiment, the application function 592 may be execute on an application server 559 located geographically proximate to the UE 552 in an “edge computing” deployment mode. The core network 558 can provide a network slice to a subscriber, for example an enterprise customer, that is composed of a plurality of 5G network functions that are configured to provide customized communication service for that subscriber, for example to provide communication service in accordance with communication policies defined by the customer. The NSSF 574 can help the AMF 576 to select the network slice instance (NSI) for use with the UE 552.

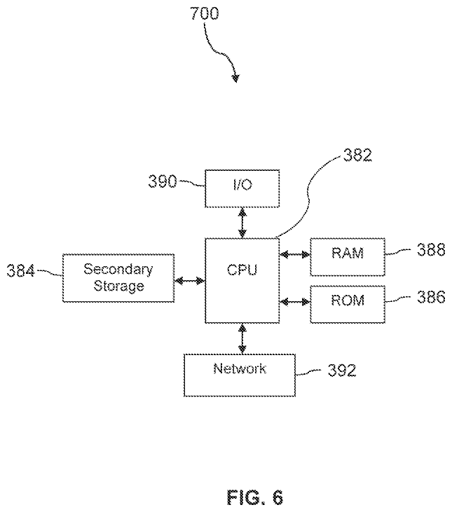

FIG. 6 illustrates a computer system 700 suitable for implementing one or more embodiments disclosed herein. In an embodiment, the clients 103 and 106, the authorization server 112, the identity management server 115, and the core access NE 135 may each be implemented as the computer system 700. The computer system 700 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 700, at least one of the CPU 382, the RAM 388, and the ROM 386 are changed, transforming the computer system 700 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 700 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 700 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 700 to provide the functionality of a number of servers that is not directly bound to the number of computers in the computer system 700. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 700, at least portions of the contents of the computer program product to the secondary storage 384, to the ROM 386, to the RAM 388, and/or to other non-volatile memory and volatile memory of the computer system 700. The processor 382 may process the executable instructions and/or data structures in part by directly accessing the computer program product, for example by reading from a CD-ROM disk inserted into a disk drive peripheral of the computer system 700. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 700.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 700 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method implemented in a communication network including an Internet Protocol (IP) Media Subsystem (IMS) core network to perform point-of-use token validation, wherein the method comprises:
receiving, by a core application executing at a core access network element in the IMS core network, a registration message from a client, wherein the registration message comprises a first access token and a mobile station international subscriber directory number (MSISDN) of the client;
authenticating, by an authorization application at an authorization server communicatively coupled to the IMS core network, the first access token based on a current and valid access token assigned to the client;
verifying, by an identity application at an identity management server communicatively coupled to the IMS core network, that the MSISDN of the client is indicated as being permitted to use the first access token based on a client account associated with the client;
performing, by the core application at the IMS core network, a registration of the client with the IMS core network based on the MSISDN of the client;
maintaining, by the core application, the registration of the client with the IMS core network by automatically performing one or more refresh operations on the registration of the client with the IMS core network;
receiving, by the core application, an access request from the client, wherein the access request comprises a second access token of the client, the MSISDN of the client, an indication of a requested service, and a MSISDN of a second client, wherein the requested service is to complete a call from the client to the second client;
authenticating, by the authorization application at the authorization server, the second access token based on the current and valid access token assigned to the client;
verifying, by the identity application at the identity management server, at least one of the MSISDN of the client, the MSISDN of the second client, or the requested service based on the client account; and
providing, by the IMS core network, the requested service to the client.

2. The method of claim 1, wherein the first access token has a validity time period, and wherein after the validity time period, the first access token is expired and the second access token becomes valid.

3. The method of claim 1, further comprising:
receiving, by the authorization application at the authorization server, security credentials to access the client account; and
verifying, by the authorization application at the authorization server, a validity of the first access token in response to accessing the client account.

4. The method of claim 1, further comprising obtaining, by the identity application of the identity management server, a verification parameter indicating that the MSISDN of the client is permitted to use the first access token based on the client account.

5. The method of claim 1, wherein performing, by the core application, the registration of the client with the IMS core network based on the MSISDN of the client comprises:
transmitting, by the core application to a registration application at the IMS core network, a session initiation protocol (SIP) register message comprising the MSISDN of the client; and
receiving, by the core application from the registration application, a SIP response message indicating a status of performing the registration of the client with the IMS core network.

6. The method of claim 5, wherein the one or more refresh operations comprises transmitting another SIP register message comprising the MSISDN of the client according to a predefined schedule.

7. The method of claim 1, wherein prior to receiving, by the core application, the access request from the client, the method further comprises:
receiving, by the authorization application at the authorization server, a refresh token associated with the client and the first access token from the client;
authenticating, by the authorization application at the authorization server, the client based on both the refresh token and the first access token; and
providing, by the authorization application at the authorization server, the second access token to the client.

8. The method of claim 1, wherein the client account comprises a list of MSISDNs identifying clients that are permitted to access the IMS core network, a list of MSISDNs identifying second clients that the clients are permitted to communicate with using the IMS core network, and a list of services that the clients are permitted to receive using the IMS core network.

9. A method implemented in a communication network including an Internet Protocol (IP) Media Subsystem (IMS) core network to perform point-of-use token validation, wherein the method comprises:
performing, by a core application executing at a core access network element in the IMS core network, a registration of a first client with the IMS core network based on a mobile station international subscriber directory number (MSISDN) of the first client and an access token associated with the first client;
maintaining, by the core application, the registration of the first client with the IMS core network based on the access token used while performing the registration of the first client with the IMS core network;
receiving, by the core application, an access request for a requested service from a second client, wherein the requested service is to complete a call from the second client to the first client;
transmitting, by the core application to the first client, an incoming service notification indicating that an anonymized service has been requested involving the first client;
in response to transmitting the incoming service notification to the first client, receiving, by the core application, an access request from the first client, wherein the access request comprises the access token of the first client and the MSISDN of the first client;
authenticating, by an authorization application at an authorization server communicatively coupled to the IMS core network, the access token based on a current and valid access token assigned to the first client;
verifying, by an identity application at an identity management server communicatively coupled to the IMS core network, at least one of the MSISDN of the first client, a second MSISDN identifying the second client, or the requested service based on a client account associated with the first client; and
completing, by the IMS core network, the requested service between the second client and the first client.

10. The method of claim 9, wherein the access token has a validity time period during which the access token is valid.

11. The method of claim 9, further comprising:
receiving, by the authorization application at the authorization server, security credentials to access the client account; and
verifying, by the authorization application at the authorization server, a validity of the access token in response to accessing the client account.

12. The method of claim 9, wherein performing, by the core application, the registration of the first client with the IMS core network comprises:
transmitting, by the core application to a registration application at the IMS core network, a session initiation protocol (SIP) register message comprising the MSISDN of the first client; and
receiving, by the core application from the registration application, a SIP response message indicating a status of performing the registration of the first client with the IMS core network.

13. The method of claim 12, further comprising transmitting, by the core application, another SIP register message comprising the MSISDN of the first client according to a predefined schedule.

14. The method of claim 9, wherein after transmitting the incoming service notification to the first client, the method further comprises:
receiving, by the authorization application at the authorization server, a refresh token associated with the first client and the access token; and
verifying, by the authorization application at the authorization server, a validity of the access token; and
transmitting, by the authorization application at the authorization server, to the first client, a notification that the access token is still valid for the first client.

15. A communication network, comprising:
a core access network element comprising:
a non-transitory memory;
a processor coupled to the non-transitory memory; and
a core application stored at the non-transitory memory, which when executed by the processor, causes the processor to be configured to:
perform a registration of a first client with an Internet Protocol (IP) Media Subsystem (IMS) core network based on a mobile station international subscriber directory number (MSISDN) of the first client and an access token associated with the first client;
maintain the registration of the first client with the IMS core network by automatically performing one or more refresh operations on the registration of the first client with the IMS core network; and
receive an access request for a requested service either from the first client or a second client;
an authorization server comprising an authorization application stored at a non-transitory memory of the authorization server, which when executed by a processor of the authorization server, causes the authorization application to be configured to authenticate the access token based on a current and valid access token assigned to the first client; and
an identity management server comprising an identity application stored at a non-transitory memory of the identity management server, which when executed by a processor of the identity management server, causes the identity application to be configured to verify at least one of the MSISDN of the first client, a second MSISDN identifying the second client, or the requested service based on a client account associated with the first client, wherein the IMS core network provides the requested service between the first client and the second client in response to the access token being authenticated and the at least one of the MSISDN of the first client, the second MSISDN identifying the second client, or the requested service being validated.

16. The communication network of claim 15, wherein the core application is further configured to transmit an incoming service notification indicating that an anonymized requested service has been received for the first client.

17. The communication network of claim 15, wherein the core application is further configured to receive a registration message from the first client, wherein the registration message comprises the access token and the MSISDN of the first client, wherein the authorization application is further configured to authenticate the access token based on the client account, and wherein the identity application is further configured to verify a permission of the at least one of the MSISDN of the first client, the second MSISDN identifying the second client, or the requested service.

18. The communication network of claim 15, wherein the access token has a validity time period during which the access token is valid.

19. The communication network of claim 15, wherein the authorization application is further configured to:
receive a refresh token associated with the first client and the access token; and
verify a validity of the access token; and
transmit to the first client, a notification that the access token is still valid for the first client.

20. The communication network of claim 15, wherein the requested service comprises at least one of a call from the first client to the second client, a call from the second client to the first client, sending a message from the first client to the second client, or sending a message from the second client to the first client.
